(19) United States
(12) Patent Application Publication
(10) Pub. No.: US 2016/0037868 A1
(43) Pub. Date: Feb. 11, 2016

(54) Self-Aligning, Quick Connect and Disconnect Buckle System

(71) Applicant: MAGLAB, LLC, East Wenatchee, WA (US)

(72) Inventor: Brian Lambert, East Wenatchee, WA (US)

(21) Appl. No.: 14/780,870

(22) PCT Filed: Mar. 28, 2014
(86) PCT No.: PCT/US14/32132

§ 371 Date: Sep. 28, 2015

Related U.S. Application Data
(60) Provisional application No. 61/806,229, filed on Mar. 28, 2013.

(51) Int. Cl. A44B 11/25; F16B 1/00

(52) U.S. Cl. CPC A44B 11/25; F16B 1/00; F16B 2001/0035

(57) ABSTRACT

A self-aligning buckle connecting system that includes two end connectors each having outward facing transverse surface with one or more magnetic elements. Each magnetic element is arranged or oriented on each transverse surface to produce opposite oriented magnetic fields on opposite sides of the transverse surface's center axis. The magnetic element of the opposite transverse surface is arranged in the same manner but with its magnetic fields in the opposite directions so the transverse surfaces attract when the end connectors are in close proximity. In one embodiment, the magnetic element is a single bar magnet located on or adjacent to the transverse surface with its magnetic poles oriented in opposite directions. In another embodiment, the magnetic elements are two sets of smaller magnets perpendicularly mounted on each half of the transverse surface with their magnetic poles in each set of magnets in opposite directions.

### TECHNICAL FIELD

The present invention relates to quick attachment and release buckle connectors that self-align when placed in close proximity.

### BACKGROUND ART

A buckle is commonly used with a belt that allows the user to adjust the overall length of the belt. The buckle normally includes a rigid outer frame affixed to the end of the belt and a prong pivotally mounted to a bar that extends transversely inside the frame. When used, the belt is extended around a person's waist and the free end of the belt opposite the buckle is inserted through the buckle's frame opening and pulled to cinch the belt around the waist. The prong is then inserted into a hole formed on the belt and the distal end of the belt is then extended under the frame's cross-member and over the outer surface of the belt and eventually tucked under the trouser's belt loop.

To remove the trousers, the belt must be disconnected which requires the prong to be disengaged from the hole. This requires the user to simultaneously pull the distal end of the belt and flick the prong from the hole using his or her finger. After the prong has been removed from the hole, the belt can be released and the trousers may be removed.

An individual with impaired vision cannot insert the free distal end of a belt into frame, or sufficiently pull the belt so prong can be inserted or removed from the hole. Individuals with arthritic hands and fingers, young children, and disabled individuals sometimes also find it difficult to find a hole on the belt and to manipulation and insert the prong into the hole. Such individuals are too weak to pull the end of the strap rearward to disconnect the prong from the hole. Due to these problems, many impaired or handicapped individuals, and young children forgo wearing belts with buckles. Also when a belt is worn by such individuals, often improperly adjusted defeating the intended the belt.

Many workers wear thick gloves and find it difficult to insert the end of a belt into a frame, find it difficult to feel a desired hole on the belt, and find it difficult to manipulate the prong. Workers must remove their gloves to reconnect the belt.

### DISCLOSURE OF THE INVENTION

A self-aligning buckle connecting system that does not require manual manipulation or visual assistance. The buckle connecting system includes two end connectors with opposite facing transverse surfaces each with one or more magnetic elements affixed or mounted adjacent to the transverse surfaces. Each magnetic element is arranged or oriented on each transverse surface to produce opposite oriented magnetic fields on opposite sides of the transverse surface's center axis. The magnetic element of the opposite transverse surface is arranged in the same manner but with its magnetic fields in the opposite directions so the transverse surfaces attract when the end connectors are in close proximity.

Two key aspects of the invention are: (1) the magnet poles on the magnetic element on each end connector are on opposite sides and equal distances from the transverse surface's center axis, (the center axis also denotes the dividing line of polarization between the two magnetic fields), and (2) the adjacent magnetic elements on opposing end connectors are oriented with their magnetic fields or poles aligned in opposite directions so that attract with in close proximity.

Each end connector includes a main body with a flat, transverse surface. In one embodiment, the magnetic element is a single bar magnet located on or adjacent to the end connector's transverse surface with its magnetic poles oriented in opposite directions. In another embodiment, two smaller single bar magnets are located on opposite sides of the end connector's center axis. The smaller single bar magnets are aligned so that their magnetic poles are oriented in opposite directions and perpendicular to the transverse surface. In another embodiment, the magnetic elements are two sets of a plurality of smaller magnets perpendicularly mounted on each half of the transverse surface with their magnetic poles in each set of magnets in opposite directions.

For each embodiment, when the transverse surfaces of the two end connectors are parallel, axially aligned and brought in close proximity, the magnetic elements on the transverse surfaces pull and hold the two end connectors together. If the end connectors are misaligned, the end connectors may slide laterally or rotate until the magnetic elements with the opposite polarities are aligned.

In still other embodiment, the end connectors may include one or more pegs and one or more voids which engage when the transverse surfaces are aligned and registered. The pegs and voids prevent the end connectors from sliding laterally over each other. In another embodiment, the magnetic elements are mounted on the end of a peg on one end connector and inside a void formed on opposite end connector.

In another embodiment, the main body may include an upward extending loop with an outer surface vertically aligned with the transverse surface. When the two end connectors are connected together, the two loops are aligned and parallel and may be held together with a clip.

Each end connector may include a cover or cap that covers some or all of the magnetic elements.

The end connectors are used to attach the ends of one strap or two straps, cords or chain together. The main body may include a rear opening through which the strap, cord or chain extends. In another embodiment, the main body may be attached directly to a mounting surface on the top or bottom surface of a strap.

### BRIEF DESCRIPTION OF THE DRAWINGS

FIG. 1 is a top plan view of two end connectors attached to two ends of a strap showing them sliding together.

FIG. 2 is a side elevational view of the two connectors and straps shown in FIG. 1.

FIG. 3 is a perspective view of an end connector with four cylindrical magnetic elements mounted or attached to its outer transverse surface.

FIG. 4 is perspective view of two partial end connectors each with a single bar magnetic element mounted adjacent to its transverse surface.

FIG. 5 is perspective view of two pairs of magnetic elements that can be mounted on the transverse surfaces and showing the orientation of the magnetic elements.

FIG. 6 is a top perspective view of four pairs of cylindrical-shaped magnetic elements, with each magnetic element in each pair being oriented in opposite directions and shown a dividing line of polarity.

FIG. 7 is a side perspective view of six pairs of box-shaped magnetic elements, with each magnetic element in each pair being oriented in opposite directions and shown a dividing line of polarity.

FIG. 8 is a top plan view of another embodiment of the buckle connector system that includes one end connector with two pegs with magnetic elements attached to each peg and the other end connector with two voids with magnetic elements located inside the voids their magnetic poles oriented in opposite directions.

FIG. 9 is a side elevational view of the buckle connector system shown in FIG. 8.

FIG. 10 is a top plan view of another embodiment of the buckle connector system that includes two end connectors both with one peg with a magnetic element attached to each peg and with one void with a magnetic element located inside the voids their magnetic poles oriented in opposite directions to the magnetic elements on the pegs.

FIG. 11 is a perspective view of a bag that uses two buckle connector systems with one end connector mounted on the outside surface of the bag and the other end connector mounted on the end of a pull down strap attached to the side of the bag.

FIG. 12 is a top plan view of two end connectors attached to strap with plate bar magnets with their magnetic poles oriented in opposite directions.

FIG. 13 is a perspective view of another embodiment of two end connectors in which the main body of each end connector includes an upward extending loop with an outer surface vertically aligned with the transverse surface on the main body.

FIG. 14 is a side elevational view of the two end connectors shown in FIG. 13.

FIG. 15 is a side elevational view of the two end connectors joined with a clip extending through the two upper loops.

FIG. 16 is a top plan view of another embodiment of two end connectors that uses a flat main body with two magnetic elements perpendicularly aligned with the transverse surfaces and with rear openings opposite the transverse surfaces that connect to a cord or cable.

FIG. 17 is the side elevational view of the two end connectors shown in FIG. 16.

### BEST MODE FOR CARRYING OUT THE INVENTION

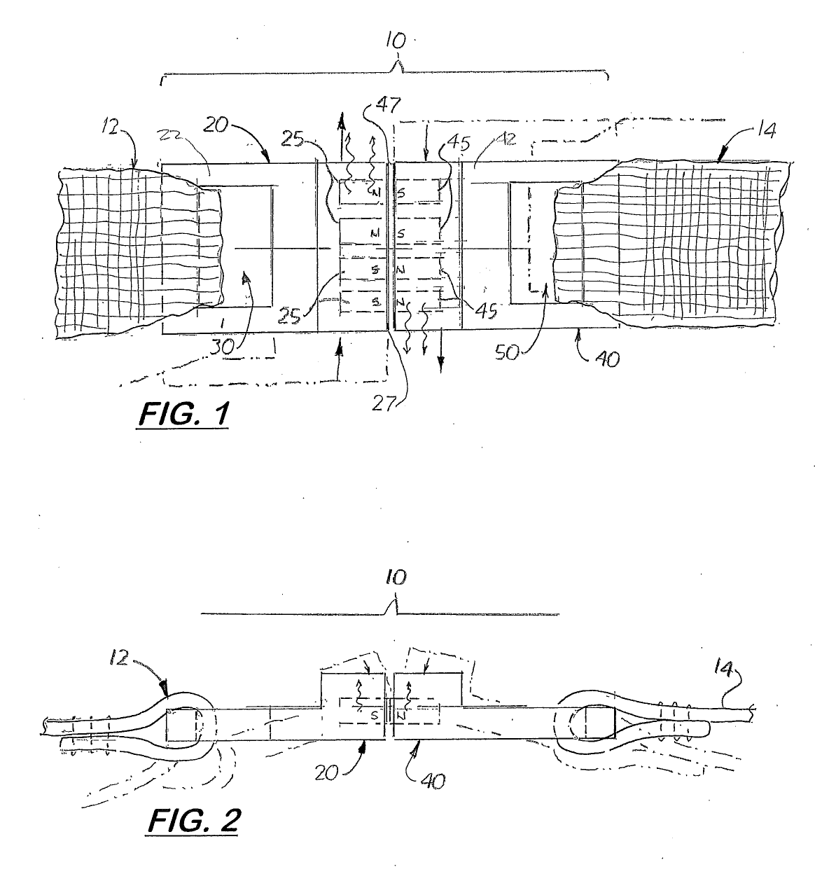

Referring to the accompanying FIGS. 1-5, there is shown a buckle connector system 10 that includes two end connectors 20, 40 each with one or more magnetic elements 25, 45 on the end connectors transverse surfaces 27, 47, respectively, that are magnetically attached when the end connectors 20, 40 are axially aligned and in close proximity to each other. If the transverse surfaces 27, 47 on the two end connectors 20, 40 are slightly misaligned, the magnetic elements 27, 47 automatically align the two end connectors 20, 40. If the transverse surfaces 27 47 are completely misaligned, the end connectors will automatically adjust their positions so some all of the magnetic elements 27, 47 may join together.

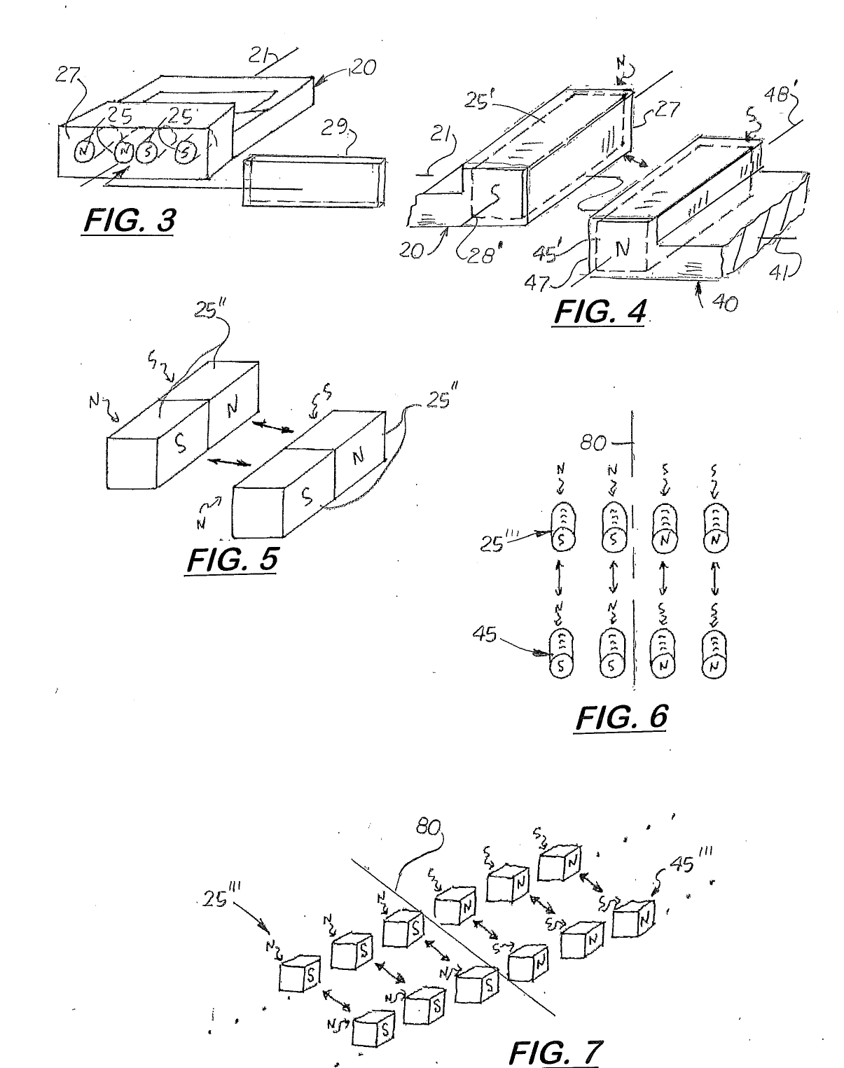

As shown in FIGS. 1-5, the buckle connector system 10 includes two end connectors 20, 40 affixed to the ends of two strap sections 12, 14 intended to be temporarily joined. Each end connector 20, 40 includes a flat main body 22, 42, respectively, with one or more magnetic elements 25, 45 mounted or attached to its outer transverse edge 27, 47. The magnetic elements 25, 45 are aligned so their longitudinal axes are perpendicularly aligned to the end connector's transverse edge 27, 47, respectively. The magnetic elements 25, 45 are aligned on each end connector 20, 40 so that the north and south poles are aligned with the transverse surface 27, 47 and in opposite directions so the magnetic forces draw the end connectors 20, 40 together when brought in close proximity. The magnetic elements 25, 45 have sufficient magnetic flux so end connectors self-align when place in a proximity to each other (approximately ½ inch apart). Because the lines of force are transversely aligned on each magnetic element 25, 45, the end connectors 20, 40 may be easily connected and disconnected by sliding the two end connectors 20, 40 together as shown in FIGS. 1 and 3.

FIG. 3 is a perspective view of an end connector 20 with four cylindrical magnetic elements 25 mounted or attached to its outer transverse surface 27. As shown in FIGS. 1 and 3, two magnetic elements 25 are mounted on one side of the transverse surface 27 with their north poles exposed and two magnetic elements 25 are mounted on the opposite side of the transverse surface 27 with their south poles exposed. In the preferred embodiment, the two pairs of magnetic elements 25 are evenly aligned on opposite sides of the end connector's longitudinal axis 21. An optional cover 29 may be placed over the transverse surface 27 to hind the magnetic elements 25.

FIG. 4 is perspective view of two partial end connectors 20, 40 each with a single bar magnetic element 25′, 45′, respectively, mounted adjacent to its transverse surfaces 27, 47. Each single bar magnetic element 25′, 45′ includes a longitudinal axis 28′, 48′, respectively, that is parallel to the transverse surfaces 27, 47. In the preferred embodiment, the single bar magnetic elements 25′, 45′ are centrally aligned over the end connector's longitudinal axis 21, 41, respectively.

FIG. 5 is perspective view of two pairs of magnetic elements 25″, 45″ with their north and south poles alternatively arranged on each transverse surfaces and opposite the north and south pole arrangement on the opposite end connector.

FIG. 6 illustrates another embodiment of the invention that uses four pairs of cylindrical magnetic elements 25, 45 mounted on each end connector (not shown). The magnetic elements 25 on one end connector is arranged in an S-S-N-N manner and arranged in the opposite end connector in an N-N-S-S. The magnetic elements 25 on one end connector are aligned and registered with the magnetic elements 45 on the other end connector. Extended between the two pairs of magnetic elements is a dividing line of polarity 80 of the magnetic elements in which the magnetic elements on one side of the dividing line 80 or polarity have the magnetic fields aligned in the same direction.

FIG. 7 illustrates another embodiment of the invention that uses six pairs of cubed-shaped magnetic elements 25′, 45′″ oriented so their polarities are the same on each side of the dividing line of polarity 80.

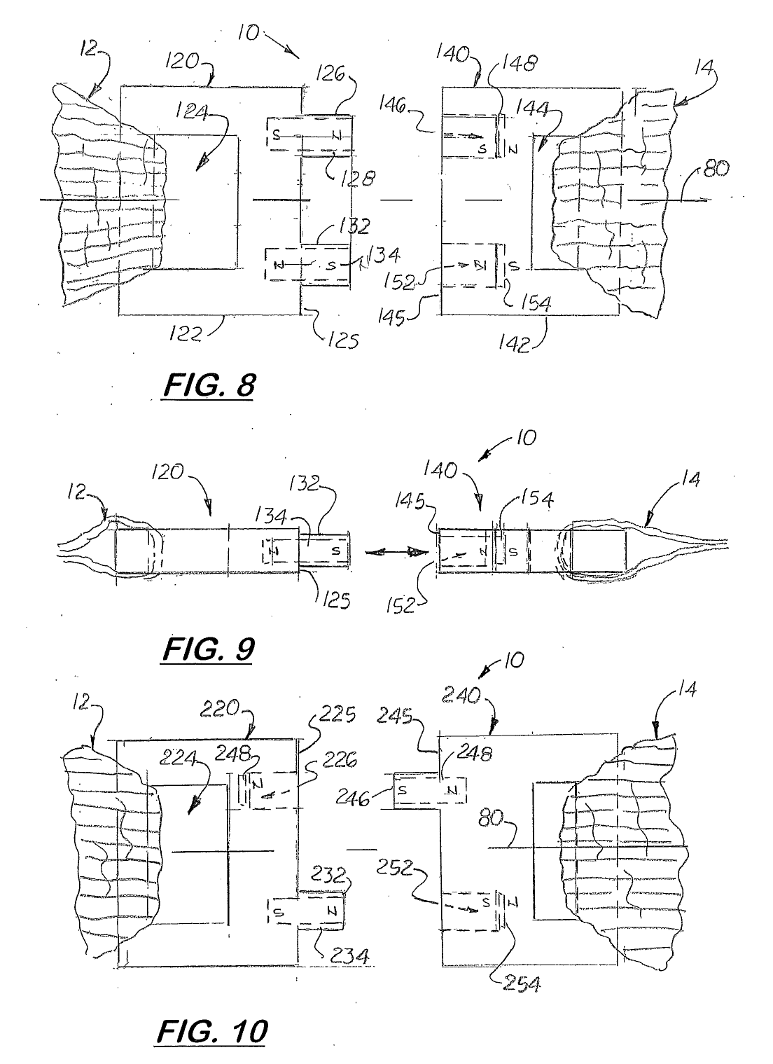

FIG. 8 is a top plan view of another embodiment of the buckle connector system 10 that includes one end connector 120 with two pegs 126, 132 each with a magnetic element 128, 134 longitudinally aligned and a second end connector 140 with two voids 146, 152 also with magnetic elements 148, 154, respectively located inside the inside surface of the voids 146, 152. The magnetic elements 128, 132 are oriented with their north and south poles oriented in opposite directions. The magnetic elements 144, 154 are flat disc magnets with their magnetic north and south poles oriented in opposite directions to each other and opposite the north or south poles orientation of the magnetic element 128, 132. Each end connector 120, 140 includes a main body 122, 142 with a strap opening 124, 144. The two pegs 126, 132 and the two voids 146, 152 are perpendicularly aligned to the transverse surfaces 125, 145, respectively. The diameters and lengths of the pegs 126, 132 and voids 146, 152 are sufficient so the two transverse surfaces 125, 145 are parallel and adjacent to each other when the two end connectors 120, 140 are attached. The magnetic elements 128, 134, 148 and 154 are equally spaced apart on opposite sides of the dividing line of polarity 80.

FIG. 9 is a side elevational view of the two end connectors 120 and 140 shown in FIG. 8.

FIG. 10 is a top plan view of another embodiment of the buckle connector system 10 that includes two end connectors 220, 240 each with one peg 232, 246 perpendicularly aligned and extending outward from the transverse surfaces 225, 245, respectively. Each end connector 20, 240 also includes a perpendicular aligned void 226, 252 that extends inward from the transverse surface 225, 245, respectively. A magnetic element 234, 248 longitudinally mounted attached to each peg 232, 246 and one magnetic element 248, 254 is disposed inside each voids 226, 252. The magnetic elements 232, 248 and 248, 254 on each end connector 220, 240, respectively, are oriented with their magnetic poles in opposite directions and opposite to the orientation of the magnetic elements on the opposite end connector 220, 240. The magnetic elements 232, 248 and 248, and 254 are equally spaced apart on opposite sides of the dividing line of polarity 80. The diameters and lengths of the pegs 234, 236 and the voids 226, 252 are sufficient so the two transverse surfaces 225, 245 are parallel and adjacent to each other when the two end connectors 220, 240 are attached.

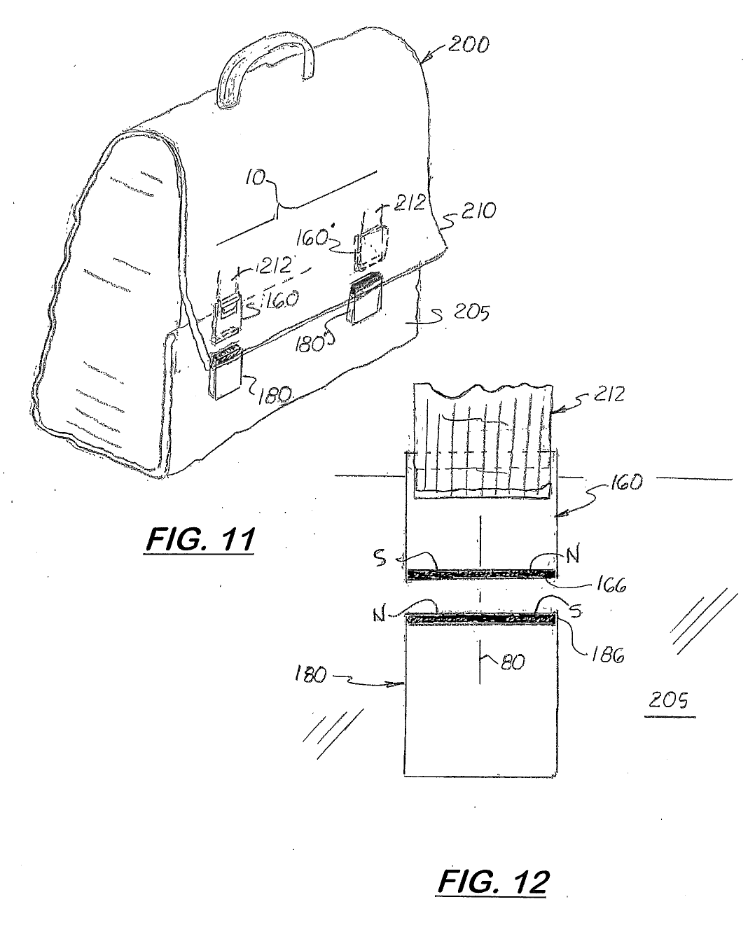

FIG. 11 is a perspective view of a bag 200 that uses two buckle connector systems 10 with two end connectors 160, 160′ mounted on straps 212, 212′ affixed to the inside surface of the bag lid 220 and two end connectors 180, 180′ mounted directly on the outside surface of the bag body 205. Each end connector 160, 180 includes a flat magnetic element 166, 186, respectively, centrally aligned on the transverse surfaces. The magnetic elements 166, 186 are oriented so their magnetic poles are aligned in opposite directions and on equal distances from the dividing line of polarity 80.

FIG. 12 is a top plan view of two end connectors 60 and 180 shown in FIG. 11.

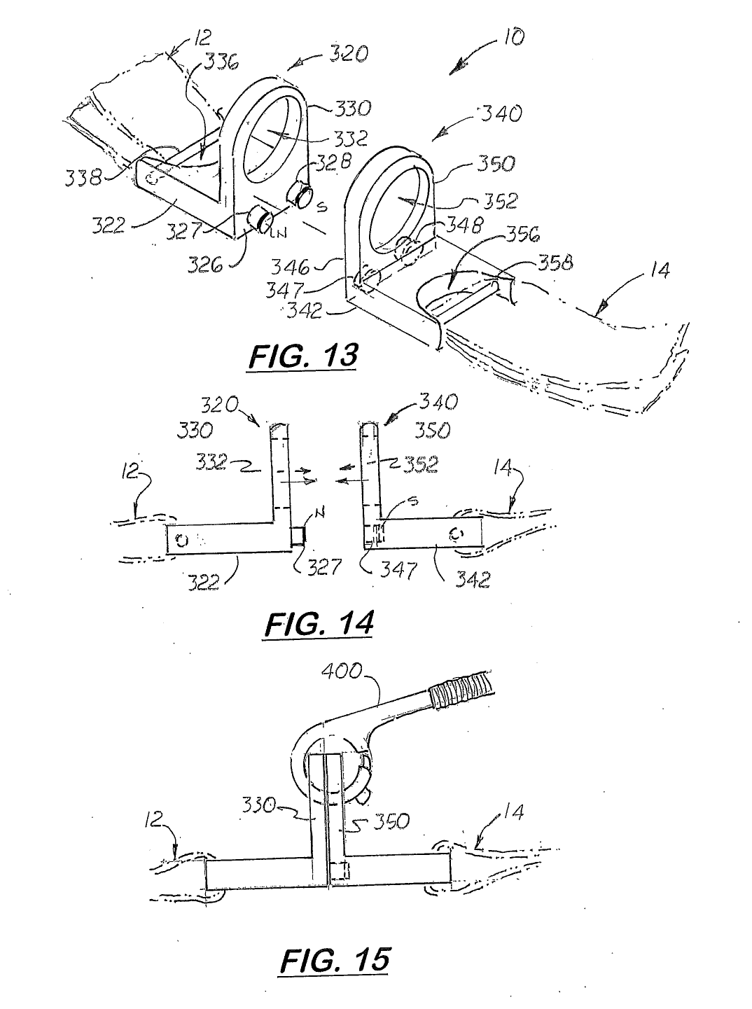

FIG. 13 is a perspective view of another embodiment of the system 10 that uses two end connectors 320, 340 with flat main bodies 322, 342 each with an upward extending loop 330, 350 with an outer surface vertically aligned with the transverse surfaces 326, 346. Each end connector 320, 340 includes a rear strap opening 336, 356. Formed or mounted on the transverse surface 326 of one end connector 320 are two pegs 327, 328 with magnetic elements attached there to. Formed on the transverse surface 346 of the opposite end connector 340 are two voids 347, 348 with magnetic elements attached inside. The diameters and lengths of the pegs 327, 328 and the voids 347, 348 are sufficient so the two transverse surfaces 326, 346 are parallel and adjacent to each other when the two end connectors 320, 340 are attached.

FIG. 14 is a side elevational view of the two end connectors shown 320, 340 in FIG. 13.

FIG. 15 is a side elevational view of the two end connectors 320, 340 joined with a clip 400 extending through the two upper loops 330, 350.

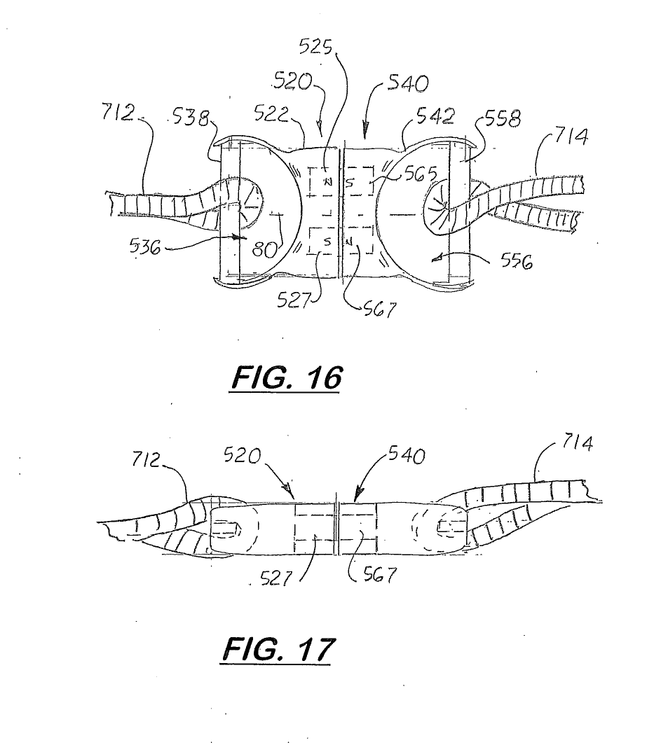

FIG. 16 is a top plan view of another embodiment of two end connectors 520, 540 that uses a flat main body 522, 542 each with two magnetic elements 525, 527 and 542, 567 perpendicularly aligned with the transverse surfaces. The pair of magnetic elements 525, 527 and 565, 567 on each end connector 520, 540, respectively, are aligned with their poles in opposite directions and are located on opposite sides of the axis 80. The main bodies 522, 542 each include a rear opening 536, 556, respectively, with a cross arm 538, 558 extending across around which a cord or cable 712, 714 extends.

FIG. 17 is the side elevational view of the two end connectors 520, 540 shown in FIG. 16.

In the various embodiments shown herein, various types, numbers and sizes of magnetic elements may be used that have sufficient magnetic fields that require 2 to 30 lbs of pulling force to separate the end connectors.

### INDUSTRIAL APPLICABILITY

This invention has application in the hardware connectors industry. More specifically, to such industries that use or require surfaces or straps to be temporarily connected together.

1. A self-aligning and auto connecting buckle connector system, comprising,
a. two end connectors each with a main body with a transverse surface and a center axis;
b. at magnetic element attached to each said end connector, said magnetic element has opposite north and south magnetic poles, said magnetic poles are positioned on or near said transverse surface and on opposite sides and equal distances from said center axis, said magnetic element on said end connectors also being oriented so that when said transverse surfaces on said end connectors are aligned and registered, said north magnetic pole on one said magnetic element is in close proximity with said south magnetic pole on said magnetic element on the adjoining said end connector; and,
c. a means for connecting said main body to a surface or a strap.

2. The buckle connector system, as recited in claim 1, wherein each said magnetic element is a single bar magnet with opposite north and south magnetic poles and aligned with their longitudinal axis parallel with said transverse surface, said bar magnets includes a center axis aligned with said center axis on said end connector, said bar magnets being oriented on said end connectors with their magnetic poles aligned in opposite directions.

3. The buckle connector system, as recited in claim 1, wherein said main body is a flat structure with said means for connecting said main body is a large opening formed on said main body opposite said transverse surface, said large opening includes a center peg around which an elongated strap, cord or chain may extend.

4. The buckle system, as recited in claim 2, further including an end cap made of non-magnetic material disposed over said transverse surface and covering said bar magnet.

5. The buckle system, as recited in claim 1, further including a plurality of magnetic elements on each said end connectors, each said end connector includes a plurality of magnetic elements aligned with their magnetic north poles perpendicularly aligned and adjacent to said transverse surface, and a plurality of magnetic elements with their magnetic south poles perpendicularly aligned and adjacent to said transverse surface, said magnetic elements with said north magnetic poles adjacent to said transverse surface and said magnetic elements with south magnetic poles adjacent to said transverse surface being equally spaced apart on opposite sides of said center axis, the orientation of said magnetic elements said end connectors being aligned in opposite directions so said end connectors automatically connect and self align when said transverse surfaces are axially aligned and moved in close proximity to each other.

6. The buckle connector system, as recited in claim 5, further including an end cap made of non-magnetic material disposed over said transverse surface and covering said magnet elements.

7. The buckle connector system, as recited in claim 6, wherein said main body is a flat structure with said strap connector being a large opening formed on said main body opposite said transverse surface, said large opening includes a center peg around which an elongated strap, cable or chain extends.

8. The buckle connector system, as recited in claim 1, wherein said transverse surface on one said end connector includes a longitudinally aligned peg and said transverse surface on the other said end connector includes a longitudinally aligned void configured to received said peg when said transverse surfaces are axially aligned pressed together, said peg and said voids being equal distance from said center axis.

9. The buckle connector system, as recited in claim 8, further including one said magnetic element on said peg and one said magnetic element inside said void, said magnetic elements having magnetic poles oriented in opposite directions so they attract when axially in close proximity.

10. buckle connector system, as recited in claim 8, wherein said main body is a flat structure with said strap connector being a large opening formed on the main body opposite the transverse surface, said large opening includes a center peg around which a strap extends to connect said strap to said end connector.

11. The buckle connector system, as recited in claim 1, wherein said transverse surface on one said end connector includes a longitudinally aligned peg and said transverse surface on the other said end connector includes a longitudinally aligned void configured to received said peg when said transverse surfaces are pressed together, said peg and said voids being equal distance from said center axis.

12. The buckle connector system, as recited in claim 11, further including one said magnetic element on said peg and one said magnetic element inside said void.

13. The buckle connector system, as recited in claim 12, wherein said main body is a flat structure with said strap connector being a large opening formed on the main body opposite the transverse surface, said large opening includes a center peg around which an elongated strap, cord, or chain extends.

14. The buckle connector system, as recited in claim 11, further including an upward extending member with an outside mounting surface formed on each said end connector aligned with said transverse surface, each said upward extending member includes an upper opening aligned and registered when said end connectors are pressed together.

15. The buckle connector system, as recited in claim 1, wherein said transverse surface is planar.

16. A pair auto aligning and auto connecting buckle connectors comprising;
two end connectors each with a main body with a center axis and an outer transverse surface with at least one least bar magnet with a magnetic north pole and a magnetic south pole, said bar magnet being longitudinally aligned with said transverse surface, each said bar magnet includes a center transverse axis located equal distance between magnetic north pole and said magnetic south pole that is coaxially aligned with said center axis on said main body, said bar magnets being oriented on said end connectors so their magnetic north pole and a magnetic south poles are oriented in opposite directions.

17. The buckle connectors, as recited in claim 16, wherein said transverse surface on one said end connectors includes a longitudinally aligned peg and said transverse surface on the opposite said end connector includes a longitudinally aligned hole configured to receive said peg when said transverse surfaces are pressed together.

18. The buckle connectors, as recited in claim 17 wherein one said magnetic body is on said peg and one said magnetic element is located inside said hole.

19. The buckle connectors, as recited in claim 17, wherein said main body on each said end connector is a flat structure with a large opening formed on the main body opposite said transverse surface, said large opening includes a center peg around which a strap, cord or chain extend.

20. The buckle connectors, as recited in 16, wherein the strength of the magnetic field produced by said magnetic bodies when said transverse surfaces of said end connectors are pressed together requires a 2 to 40 lb pulling force.
